(19) United States
(12) Patent Application Publication
(10) Pub. No.: US 2013/0163660 A1
(43) Pub. Date: Jun. 27, 2013

(54) Loop Filter Techniques for Cross-Layer prediction

(71) Applicants: Jill Boyce, Manalapan, NJ (US); Danny Hong, New York, NY (US); Adeel Abbas, West Orange, NJ (US)

(72) Inventors: Jill Boyce, Manalapan, NJ (US); Danny Hong, New York, NY (US); Adeel Abbas, West Orange, NJ (US)

(73) Assignee: Vidyo Inc.

(21) Appl. No.: 13/533,315

(22) Filed: Jun. 26, 2012

Related U.S. Application Data
(60) Provisional application No. 61/503,807, filed on Jul. 1, 2011.

(51) Int. Cl. H04N 7/26

(52) U.S. Cl. CPC H04N 19/00896
USPC 375/240.02

(57) ABSTRACT

Disclosed are techniques for loop filtering in scalable video coding/decoding. An enhancement layer decoder decodes, per sample, coding unit, slice, or other appropriate syntax structure, an indication rlssp indicative of a stage in the base layer loop filter process. Reference sample information from a base layer for inter-layer prediction is taken from the indicated stage of the base layer loop filter.

### CROSS-REFERENCE TO RELATED APPLICATION

This application claims priority to U.S. Ser. No. 61/503,807, titled “Loop Filter Techniques for Cross-Layer Prediction,” filed Jul. 1, 2011, the disclosure of which is hereby incorporated by reference in its entirety.

### FIELD

The disclosed subject matter relates to video coding techniques for loop filtering in SNR or spatial scalability coding with cross-layer prediction.

### BACKGROUND

Video coding techniques using loop filtering techniques have been known since at least ITU-T Rec. H.261 (1989) (available from International Telecommunication Union (ITU), Place des Nations, 1211 Geneva 20, Switzerland, and incorporated herein by reference in its entirety). Like other video coding standards, H.261 uses motion compensated prediction and transform coding of the residual. Referring to FIG. 1, shown is an exemplary encoder (only inter-mode shown). An input picture (101) is forward encoded in the forward encoder (102). The forward encoder can involve techniques such as motion compensation, transform and quantization, and entropy coding of the residual signal. The resulting bitstream (103) (or a representation of it that may not be entropy coded) is subjected to a decoder (104), creating a reconstructed picture (105). The reconstructed picture or parts thereof can be exposed to a loop filter (106) configured to improve the quality of the reconstruction. The output of the loop filter is a loop filtered picture (107), that can be stored in the reference picture buffer (108). The reference picture(s) stored in the reference picture buffer (108) can be used in further picture coding by the forward encoder (102). The term “loop” filter reflects that the filter is filtering information that is re-used in future operations of the coding loop.

FIG. 2 shows an exemplary decoder in inter mode. The input bitstream (201) is processed by a decoder (202) so to generate a reconstructed picture (203). The reconstructed picture is exposed to a loop filter (204) configured to improve the quality of the reconstruction. The loop-filtered picture can be stored in a reference picture buffer (205), and may also be output (206). The reference picture(s) stored in the reference picture buffer can be used in the decoding of future input pictures.

In order to maintain integrity between the states of the encoder and the decoder (also known as avoiding drift), the encoder and decoder loop filters, for a given input, should produce identical results. Loop filter designs are typically subject to video coding standardization. In contrast, pre-filters (that are concerned with modifying the input signal (101) of an encoder, or post filters (that are concerned with the output signal (206) of a decoder, are not commonly standardized.

Loop filters can address different tasks. ITU-T Rec. H.261 (1989), for example, included, in the loop, a deblocking filter, which can be enabled or disabled per macroblock, and which is configured to combat blocking artifacts resulting from the per-block processing of the H.261 encoder in combination with overly aggressive quantization.

The Joint Collaborative Team for Video Coding (JCT-VC) has proposed a High Efficiency Video Coding (HEVC) standard, a draft of which can be found as “Bross et. al., High efficiency video coding (HEVC) text specification draft 6, JCTVC-H1003_dK, February 2012” (henceforth referred to as “WD6” or “HEVC”), available from http://phenix.intevry.fr/jct/doc_end_user/documents/8_SanJose/wg11/JCTVC-H1003 -vdK, zip (henceforth referred to as “WD6”), which is incorporated herein by reference in its entirety.

WD6 includes certain loop filtering techniques.

The loop filtering mechanism of WD6 are located within the workflow of an encoder as outlined in FIG, 1 and FIG. 2 for encoder and decoder, respectively; specifically, after reconstruction of an encoded picture and before reference picture storage. FIG. 3 shows HEVC's multistage loop filter with its three sub-filters, shown as squares. They operate on interim pictures shown as rectangles. The picture as produced by the reconstruction process (301) is first exposed to a deblocking filter (302) configured to reduce or eliminate blocking artifacts. The resulting interim picture (303) is exposed to a sample adaptive offset (SAO) mechanism (305), and its output picture (306) is subjected to an Adaptive Loop Filter (307) which produced an output picture (308). Both SAO and ALF are configured to improve the overall quality of the reconstructed picture and are not specifically targeted towards certain types of artifacts. The output of the adaptive loop filter (308) can be stored in the reference picture buffer. Parameters for SAO and ALF are selected by the encoder, and part of the bitstream. In the test model encoder, described, for example, in McCann, Boss, Sekiguchi, Han, “HM6: High Efficiency Video Coding (HEVC) Test Model 6 Encoder Description”, JCT-VC-H1002, February 2012, available from http://phenix.intevry.fr/jct/doc_end_user/documents/8_SanJose/wg11/JCTVC-H1002-v1.zip henceforth HM6, incorporated by reference in its entirety, the ALF parameters are selected with a Wiener filter, to minimize the error between the coded picture and input picture. The encoder may choose to disable SAO and ALF, using flags present in the sequence parameter set, in which case the sub-filter in question does not modify the samples. For example, if the SAO sub-filter (305) is disabled, then reference pictures (303) and (306) can contain the same values.

As in previous video coding standards, the filters mentioned above can work on whole pictures or parts thereof, for example blocks or coding units (CUs). In some implementations, the filters can be tightly integrated with each other, in which case the interim pictures may not exist in physical form. The choice of the implementation strategy in this regard depends on hardware and software architecture constraints (for example cache characteristics, and need for parallelization) as well as application requirements, such as delay requirements.

Video compression using scalable techniques in the sense used herein allows a digital video signal to be represented in the form of multiple layers. Scalable video coding techniques have been proposed and/or standardized for many years.

ITU-T Rec. H.262, entitled “Information technology—Generic coding of moving pictures and associated audio information: Video”, version February 2000, (available from International Telecommunication Union (ITU), Place des Nations, 1211 Geneva 20, Switzerland, and incorporated herein by reference in its entirety), also known as MPEG-2, for example, includes in some aspects a scalable coding technique that allows the coding of one base and one or more enhancement layers. The enhancement layers can enhance the base layer in terms of temporal resolution such as increased frame rate (temporal scalability), spatial resolution (spatial scalability), or quality at a given frame rate and resolution (quality scalability, also known as SNR scalability).

ITU Rec. H.263 version 2 (1998) and later (available from International Telecommunication Union (ITU), Place des Nations, 1211 Geneva 20, Switzerland, and incorporated herein by reference in its entirety), also includes scalability mechanisms allowing temporal, spatial, and SNR scalability. Specifically, an SNR enhancement layer according to 11.263 Annex O is a representation of what H.263 calls the “coding error”, which is calculated between the reconstructed image of the base layer and the source image. An H.263 spatial enhancement layer can be decoded from similar information, except that the base layer reconstructed image has been upsampled before calculating the coding error, using an interpolation filter. 11.263 includes loop filters in at least two of its optional modes, Annex F Advanced Prediction and Annex J Deblocking Filter.

ITU-T Rec. H.264 version 2 (2005) and later (available from International Telecommunication Union (ITU), Place des Nations, 1211 Geneva 20, Switzerland, and incorporated herein by reference in its entirety), and their respective ISO-IEC counterpart ISO/IEC 14496 Part 10 includes scalability mechanisms known as Scalable Video Coding or SVC, in its Annex G. Again, while the scalability mechanisms of H264 and Annex G include temporal, spatial, and SNR scalability (among others such as medium granularity scalability), the details of the mechanisms used to achieve scalable coding differ from those used in H.262 or H.263. H.264 can include a deblocking filter in both base layer and enhancement layer coding loop. With respect to loop filtering, in SVC spatial scalability, and when in INTRA_BL mode, base layer intra coded macroblocks (MBs) are decoded by the base layer decoder and then upsampled and used as a predictor for coding intra coded MBs in the enhancement layer. The disable_inter_layer_deblocking_filter_idc syntax element in the enhancement layer's slice header scalability extension can be used to indicate whether upsampling is performed to the decoded sample immediately after the core decoder and before the deblocking filtering, or if the upsampling is performed to the deblocked decoded samples. This can allow the enhancement layer encoder to select which mode of operation has the best coding efficiency.

Spatial and SNR scalability can be closely related in the sense that SNR scalability, at least in some implementations and for some video compression schemes and standards, can be viewed as spatial scalability with an spatial scaling factor of 1 in both X and Y dimensions, whereas spatial scalability can enhance the picture size of a base layer to a larger format by, for example, factors of 1.5 to 2.0 in each dimension. Due to this close relation, described henceforth is only spatial scalability.

The specification of spatial scalability in H.262, H.263, and H.264 differs at least due to different terminology and/or different coding tools of the non-scalable specification basis, and different tools used for implementing scalability. However, one exemplary implementation strategy for a scalable encoder configured to encode a base layer and one enhancement layer is to include two encoding loops: one for the base layer; the other for the enhancement layer. Additional enhancement layers can be added by adding more coding loops. Conversely, a scalable decoder can be implemented by a base decoder and one or more enhancement decoder(s).

Referring to FIG. 4, shown is a block diagram of an exemplary scalable encoder. It includes a video signal input (401), a downsample unit (402), a base layer coding loop (403), a base layer reference picture buffer (404) that can be part of the base layer coding loop, an upsample unit (405), an enhancement layer coding loop (406), and a bitstream generator (407).

The video signal input (401) can receive the to-be-coded video in any suitable digital format, for example according to ITU-R Rec. BT.601 (March 1982) (available from International Telecommunication Union (ITU), Place des Nations, 1211 Geneva 20, Switzerland, and incorporated herein by reference in its entirety). The term “receive” can involve pre-processing procedures such as filtering, resampling to, for example, the intended enhancement layer spatial resolution, and other operations. The spatial picture size of the input signal is assumed herein to be the same as the spatial picture size of the enhancement layer. The input signal can be used in unmodified form (408) in the enhancement layer coding loop (406), which is coupled to the video signal input.

Coupled to the video signal input can also be a downsample unit (402). The purpose of the downsample unit (402) can be to down-sample the pictures received by the video signal input (401) in enhancement layer resolution, to a base layer resolution. Video coding standards as well as application constraints can set constraints for the base layer resolution. The scalable baseline profile of H.264/SVC, for example, allows downsample ratios of 1.5 or 2.0 in both X and Y dimensions. A downsample ratio of 2.0 means that the downsampled picture includes only one quarter of the samples of the non-downsampled picture. In the aforementioned video coding standards, the details of the downsampling mechanism can generally be chosen freely, independently of the upsampling mechanism. In contrast, they generally specify the filter used for up-sampling, so to avoid drift in the enhancement layer coding loop (405).

The output of the downsampling unit (402) is a downsampled version of the picture as produced by the video signal input (409).

The base layer coding loop (403) takes the downsampled picture produced by the downsample unit (402), and encodes it into a base layer bitstream (410).

Many video compression technologies rely, among others, on inter picture prediction techniques to achieve high compression efficiency. Inter picture prediction allows for the use of information related to one or more previously decoded (or otherwise processed) picture(s), known as a reference picture, in the decoding of the current picture. Examples for inter picture prediction mechanisms include motion compensation, where during reconstruction blocks of pixels from a previously decoded picture are copied or otherwise employed after being moved according to a motion vector, or residual coding, where, instead of decoding pixel values, the potentially quantized difference between a (including in some cases motion compensated) pixel of a reference picture and the reconstructed pixel value is contained in the bitstream and used for reconstruction. Inter picture prediction is a key technology that can enable good coding efficiency in modern video coding.

Conversely, an encoder can also create reference picture(s) in its coding loop.

While in non-scalable coding, the use of reference pictures is of particular relevance in inter picture prediction, in case of scalable coding, reference pictures can also be relevant for cross-layer prediction. Cross-layer prediction can involve the use of a base layer's reconstructed picture, as well as other base layer reference picture(s) as a reference picture in the prediction of an enhancement layer picture. This reconstructed picture or reference picture can be the same as the reference picture(s) used for inter picture prediction. However, the generation of such a base layer reference picture can be required even if the base layer is coded in a manner, such as intra picture only coding, that would, without the use of scalable coding, not require a reference picture.

While base layer reference pictures can be used in the enhancement layer coding loop, shown here for simplicity is only the use of the reconstructed picture (the most recent reference picture) (411) for use by the enhancement layer coding loop. The base layer coding loop (403) can generate reference picture(s) in the aforementioned sense, and store it in the reference picture buffer (404).

The picture(s) stored in the reconstructed picture buffer (411) can be upsampled by the upsample unit (405) into the resolution used by the enhancement layer coding loop (106). The enhancement layer coding loop (406) can use the upsampled base layer reference picture (415) as produced by the upsample unit (405) in conjunction with the input picture coming from the video input (401), and reference pictures (412) created as part of the enhancement layer coding loop in its coding process. The nature of these uses depends on the video coding standard, and has already been briefly introduced for some video compression standards above. The enhancement layer coding loop (406) can create an enhancement layer bitstream (413), which can be processed together with the base layer bitstream (410) and control information (not shown) so to create a scalable bitstream (414).

FIG. 5 shows an exemplary enhancement layer coding loop (406) including a loop filter that is part of, for example, H.264 SVC. The upsampled (by upsampling unit 405) reconstructed picture of the base layer (415) can be subtracted (501) from the input picture samples (408) to create a difference picture (502). The difference picture can be subjected to a forward encoder (503), which can generate an enhancement layer bitstream (504). An in-loop decoder (505) can reconstruct the bitstream (or an interim format representative of the bitstream) and create a reconstructed picture (506). The interim picture can be loop-filtered by loop filter (507) and stored in the reference picture buffer (508) for future use by the forward encoder (503) when using inter picture prediction.

One potential drawback of the use of a loop filter in the enhancement layer in the aforementioned way is that rather than filtering samples in the input pixel domain, the loop filter filters difference samples. Difference domain samples can have very different properties when compared to pixel domain samples. This can have negative effects on the coding efficiency.

### SUMMARY

The disclosed subject matter provides techniques for loop filtering in a scalable codec environment.

In one embodiment, there are provided techniques for selecting one of a plurality of interim pictures of a base layer loop filter for use as a reference in an enhancement layer. In the same or another embodiment, the selected interim picture is indicated in an enhancement layer bitstream by an indication such as “rlssp,” which can be written into the enhancement layer bitstream by an encoder, and decoded from the enhancement layer bitstream by a decoder.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a non-scalable video encoder in accordance with Prior Art;

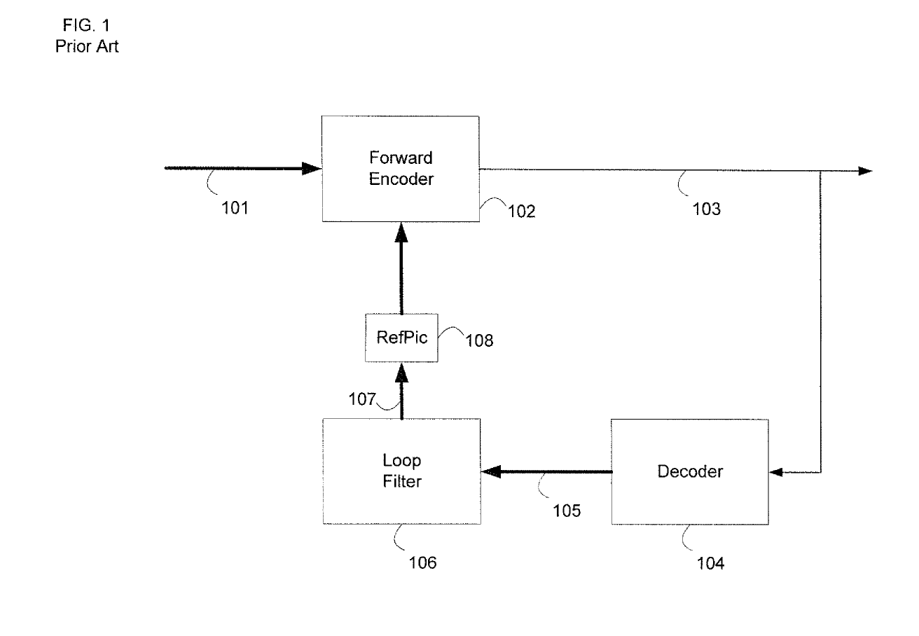

FIG. 2 is a schematic illustration of a non-scalable video decoder in accordance with Prior Art;

FIG. 3 is a schematic illustration of a loop filter of HEVC in accordance with Prior Art;

FIG. 4 is a schematic illustration of a scalable video encoder in accordance with Prior Art;

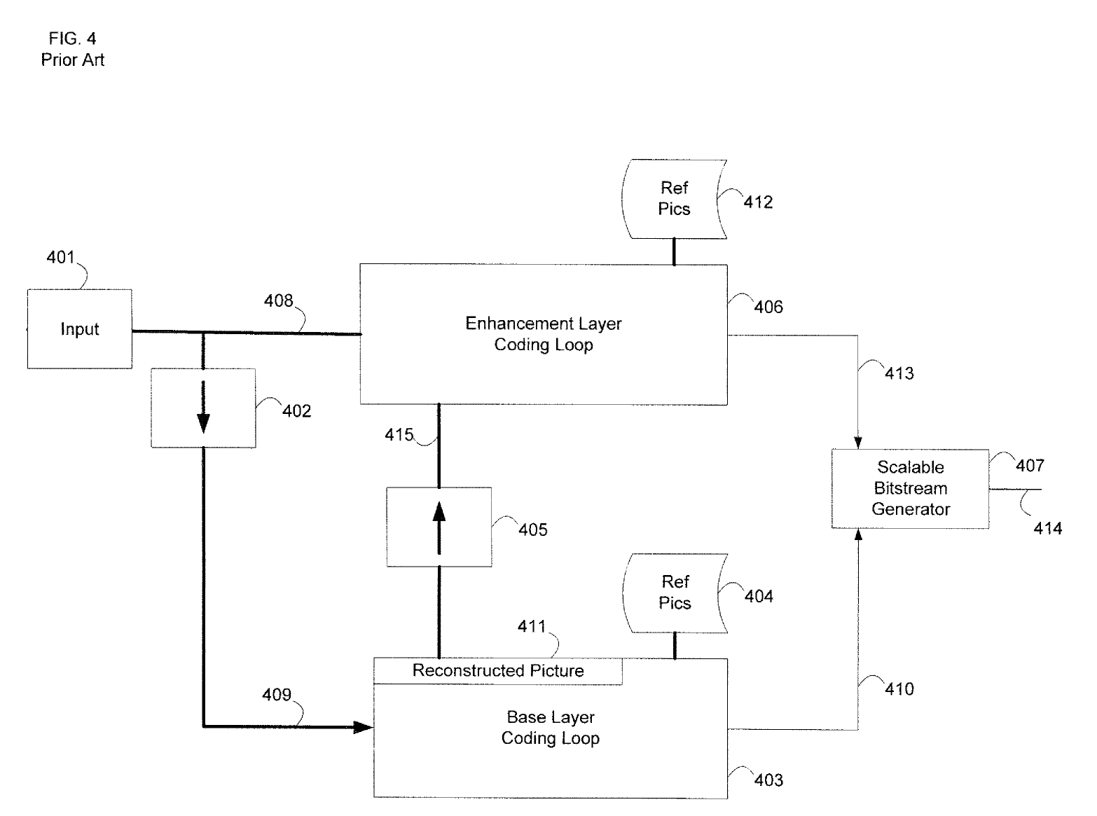

FIG. 5 is a schematic illustration of an exemplary enhancement layer encoder;

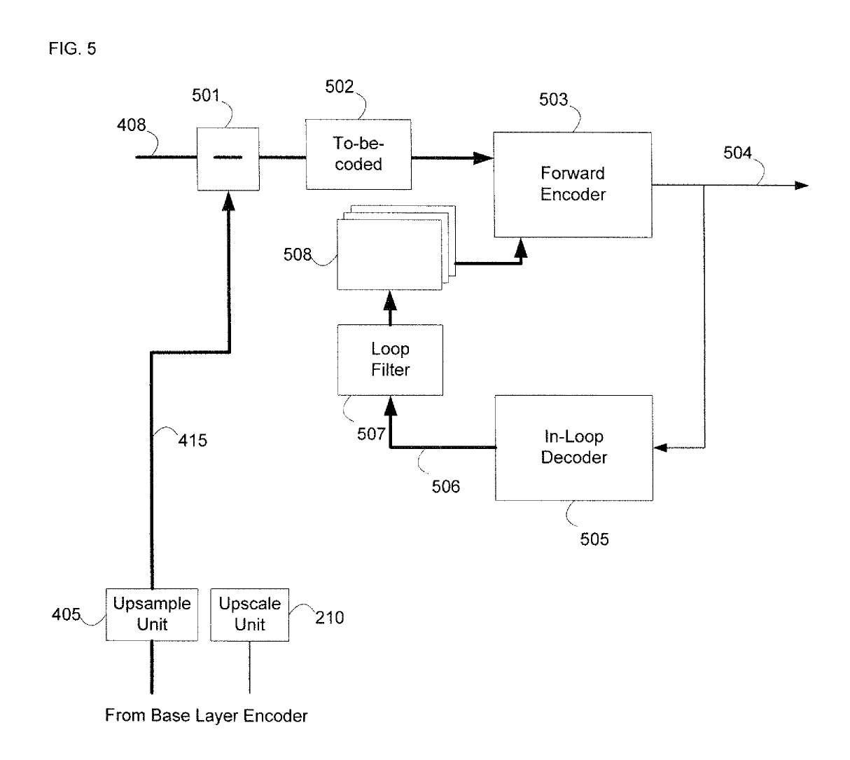

FIG. 6 is a schematic illustration of an exemplary encoder in accordance with an embodiment of the present disclosure;

FIG. 7 is a schematic illustration of an exemplary enhancement layer encoder in accordance with an embodiment of the present disclosure;

FIG. 8 is a schematic illustration of an exemplary scalable layer encoder with focus on base layer loop filter, in accordance with an embodiment of the present disclosure;

FIG. 9 is a schematic illustration of an exemplary decoder in accordance with an embodiment of the present disclosure; and

FIG. 10 shows an exemplary computer system in accordance with an embodiment of the present disclosure.

The Figures are incorporated and constitute part of this disclosure. Throughout the Figures the same reference numerals and characters, unless otherwise stated, are used to denote like features, elements, components or portions of the illustrated embodiments. Moreover, while the disclosed subject matter will now be described in detail with reference to the Figures, it is done so in connection with the illustrative embodiments.

### DETAILED DESCRIPTION

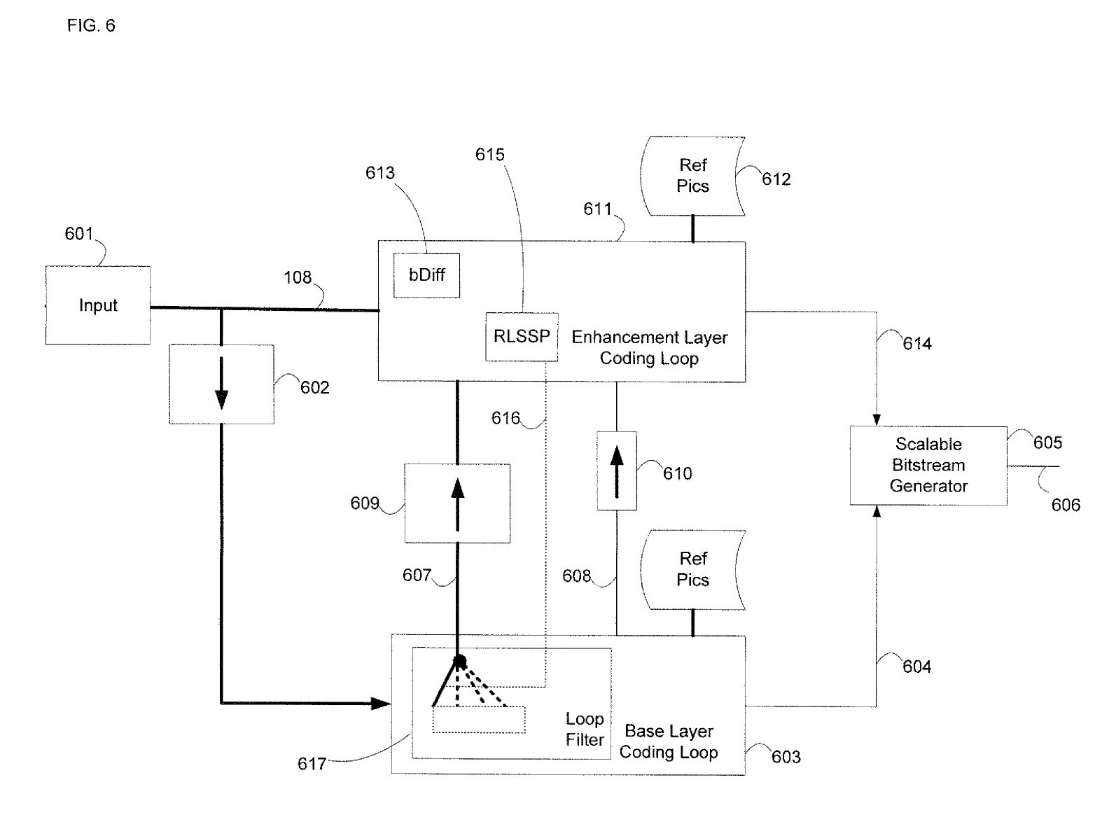

FIG. 6 shows a block diagram of an exemplary two layer encoder in accordance with an embodiment of the disclosed subject matter. However, the encoder can be extended to support more than two layers by adding additional enhancement layer coding loops. One consideration in the design of the encoder is to keep the changes to the coding loops as small as feasible.

Throughout the description of the disclosed subject matter the term “base layer” refers to the layer in the layer hierarchy on which the enhancement layer is based on. In environments with more than two enhancement layers, the base layer, as used in this description, does not need to be the lowest possible layer.

The encoder can receive uncompressed input video (601), which can be downsampled in a downsample module (602) to base layer spatial resolution, and can serve in downsampled form as input to the base layer coding loop (603). The downsample factor can be 1.0, in which case the spatial dimensions of the base layer pictures are the same as the spatial dimensions of the enhancement layer pictures; resulting in a quality scalability, also known as SNR scalability. Downsample factors larger than 1.0 lead to base layer spatial resolutions lower than the enhancement layer resolution. A video coding standard can put constraints on the allowable range for the downsampling factor. The factor can also be dependent on the application.

The base layer coding loop can generate the following output signals used in other modules of the encoder:

A) Base layer coded bitstream bits (604) which can form their own, possibly self-contained, base layer bitstream, which can be made available for examples to decoders (not shown), or can be aggregated with enhancement layer bits and control information to a scalable bitstream generator (605), which can, in turn, generate a scalable bitstream (606).

B) Reconstructed picture (or parts thereof) (607) of the base layer coding loop that may be not loop filtered or partly or fully loop filtered as described below. The base layer picture can be at base layer resolution, which, in case of SNR scalability, can be the same as enhancement layer resolution. In case of spatial scalability, base layer resolution can be different, for example lower, than enhancement layer resolution.

C) Reference picture side information (608). This side information can include, for example information related to the motion vectors that are associated with the coding of the reference pictures, macroblock or Coding Unit (CU) coding modes, intra prediction modes, and so forth. The “current” reference picture (which is the reconstructed current picture or parts thereof) can have more such side information associated with than older reference pictures.

Base layer picture and side information can be processed by an upsample unit (609) and an upscale units (610), respectively, which can, in case of the base layer picture and spatial scalability, upsample the samples to the spatial resolution of the enhancement layer using, for example, an interpolation filter that can be specified in the video compression standard. In case of reference picture side information, equivalent, for example scaling, transforms can be used. For example, motion vectors can be scaled by multiplying, in both X and Y dimension, the vector generated in the base layer coding loop (603).

An enhancement layer coding loop (611) can contain its own reference picture buffer(s) (612), which can contain reference picture sample data generated by reconstructing coded enhancement layer pictures previously generated, as well as associated side information.

In an embodiment of the disclosed subject matter, the enhancement layer coding loop can include a ref_layer_{—sample}_scaling_point determination unit (also referred to as RLSSP unit) (615). The RLSSP unit (615) can create a signal (616), to be interpreted by, for example the base layer coding loop (603) and, specifically, by a single or multistage base layer loop filter module (617) that can be located therein. The signal (616) can control the point in the multi-stage loop filtering mechanism from which the reconstructed picture samples (607) are taken. The operation of the RLSSP unit (615) and the single or multistage base layer loop filter module (617) responsive to signal (616) is described later.

In an embodiment of the disclosed subject matter, the enhancement layer coding loop further includes a bDiff determination module (613), the details of which have been described in co-pending U.S. patent application Ser. No. 13/529,159, titled “Scalable Coding Video Techniques,” the disclosure of which is incorporated herein in its entirety.

It creates, for example, a given CU, macroblock, slice, or other appropriate syntax structure, a flag bDiff. The flag bDiff, once generated, can be included in the enhancement layer bitstream (614) at an appropriate syntax structure such as a CU header, macroblock header, slice header, or any other appropriate syntax structure. In an embodiment, depending for the settings of the flag bDiff, the enhancement layer encoding loop (611) can select between, for example, two different encoding modes for the CU the flag is associated with. These two modes are henceforth referred to as “pixel coding mode” and “difference coding mode”.

“Pixel Coding Mode” refers to a mode where the enhancement layer coding loop, when coding the CU in question, can operate on the input pixels as provided by the uncompressed video input (601), without relying on information from the base layer such as, for example, difference information calculated between the input video and upscaled base layer data.

“Difference Coding Mode” refers to a mode where the enhancement layer coding loop can operate on a difference calculated between input pixels and upsampled base layer pixels of the current CU. The upsampled base layer pixels may be motion compensated and subject to intra prediction and other techniques as discussed below. In order to perform these operations, the enhancement layer coding loop can require upsampled side information. The inter picture layer prediction of the difference coding mode can be roughly equivalent to the inter layer prediction used the enhancement layer coding as described in Dugad and Ahuja (see above).

The remainder of the disclosure assumes, unless stated otherwise, that the enhancement layer coding loop operates in difference coding mode.

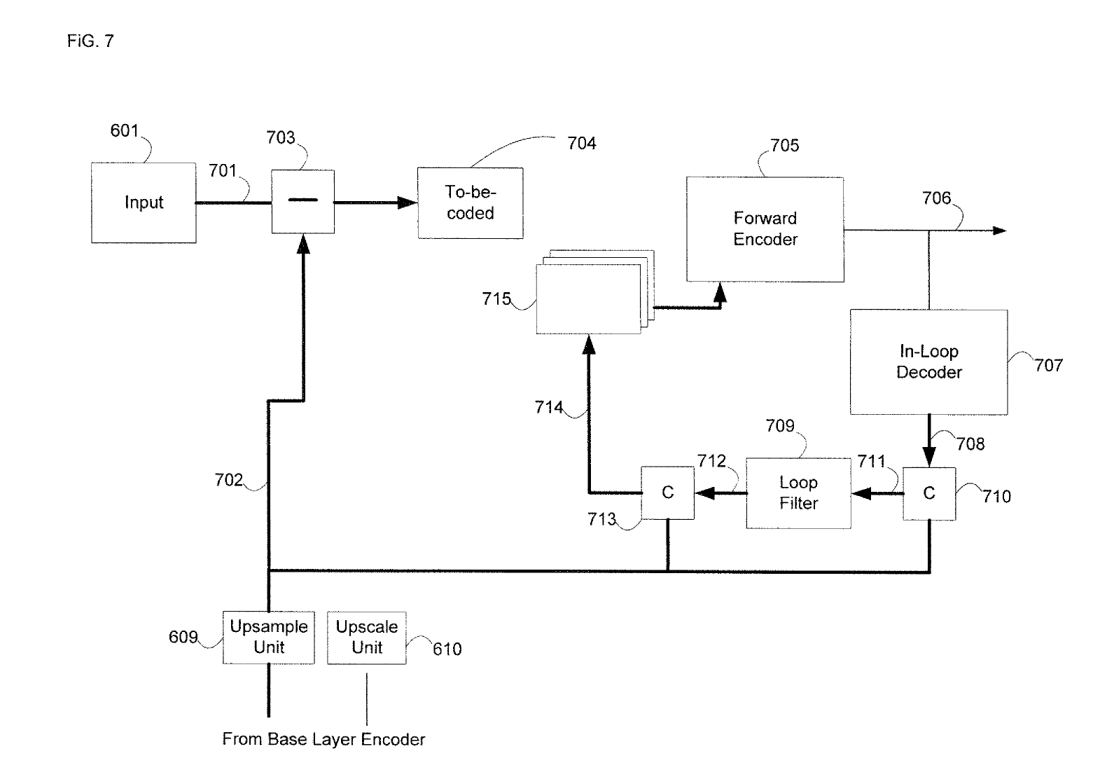

Referring to FIG. 7, shown is an exemplary implementation, following, for example the operation of HEVC with additions and modifications as indicated, of the enhancement layer coding loop (611) in difference coding mode.

The coding loop can receive uncompressed input sample data (601). It further can receive upsampled base layer reconstructed picture (or parts thereof), and associated side information, from the upsample unit (609) and upscale unit (610), respectively. In some base layer video compression standards, there is no side information that needs to be conveyed, and, therefore, the upscale unit (610) may not exist.

In difference coding mode, the coding loop can create a bitstream that represents the difference between the input uncompressed sample data (701) and the upsampled base layer reconstructed picture (or parts thereof) (702) as received from the upsample unit (609). This difference is the residual information that is not represented in the upsampled base layer samples. Accordingly, this difference can be calculated by the residual calculator module (703), and can be stored in a to-be-coded picture buffer (704). The picture of the to-be-coded picture buffer (704) can be encoded by the enhancement layer coding loop according to the same or a different compression mechanism as in the coding loop for pixel coding mode, for example by an HEVC coding loop. Specifically, an in-loop, forward encoder (705) can create a bitstream (706), which can be reconstructed by an in-loop decoder (707), so to generate an interim picture (708). The interim picture (708) is in difference mode.

It has already been pointed out that the use of an unmodified loop filter on samples in difference coding mode can lead to undesirable results. Accordingly, in the same or another embodiment, before the interim picture is exposed to a loop filter (709), it can be converted by a converter (710) from difference mode to pixel mode. The converter can, for example, for each sample in difference domain of the current CU, add the spatially corresponding sample from the upsampled base layer picture (702). The result is another interim picture (711) in the pixel domain.

In the same or another embodiment, this interim picture (711) can be loop filtered by loop filter (709) to create a loop-filtered interim picture (712), which is in pixel domain.

While this interim picture (712) is in the pixel domain, the enhancement layer coding loop in difference mode can expect a picture in the difference domain for storage in the reference picture buffer (715). Accordingly, in the same or another embodiment, the latest interim picture (712) can be converted by converter (713) into yet another interim picture (714) in the difference domain, for example by subtracting, for all pixels of the current CU, the samples of the upsampled base layer picture (702) from the samples of the interim picture (712).

Accordingly, the difference picture can be converted into the pixel domain before loop filtering, and can be converted back into the difference domain thereafter, Therefore, the loop filter can operate in the pixel domain.

U.S. application Ser. No. 13/529,159 describes improvements to avoid unnecessary conversions from pixel to difference mode and vice versa, for cases where such conversions are less optimal than, for example, keeping both pixel and difference domain representations in parallel. Some of those improvements can be applicable herein as well. For example, Ser. No. 13/529,159 describes that the reference picture of a combined pixel/difference coding loop may be kept in pixel mode only. In this case, for example, converter (713) may not be present.

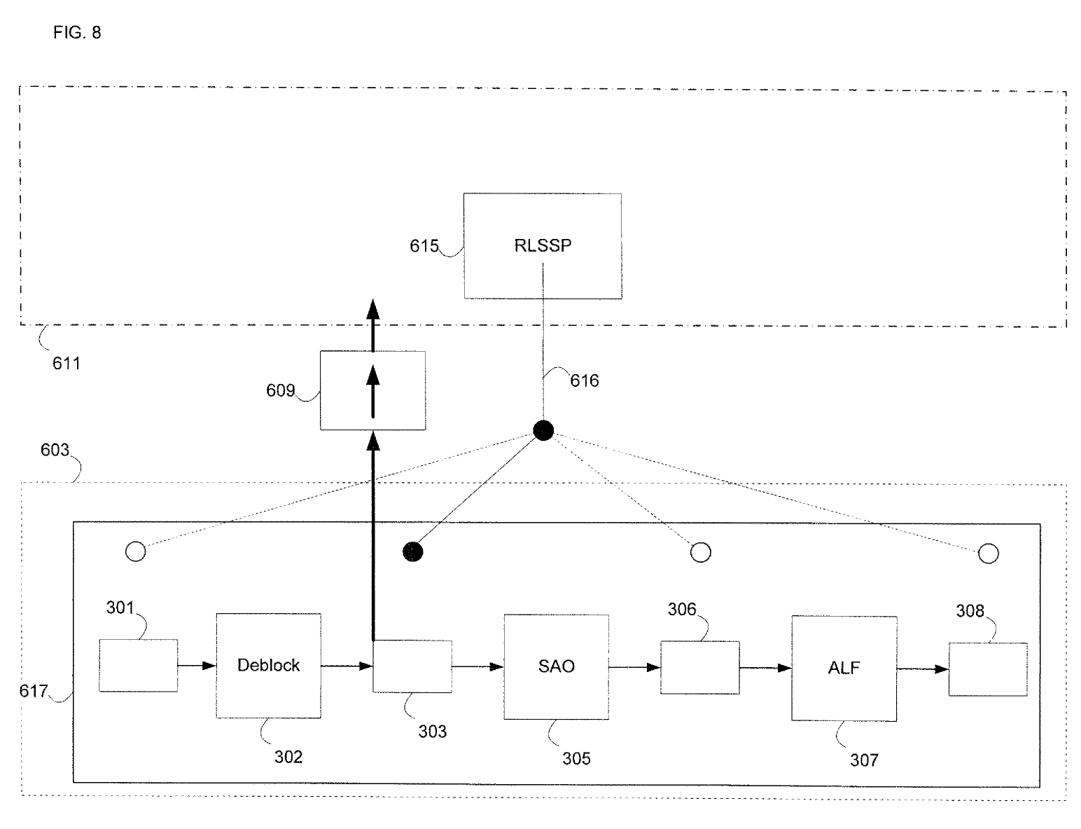

With reference to FIG. 8, described now is the RLSSP unit (615) in the enhancement layer coding loop (611), the single or multistage base layer loop filter unit (617) in the base layer coding loop (603), and the signal (616) the units use to communicate.

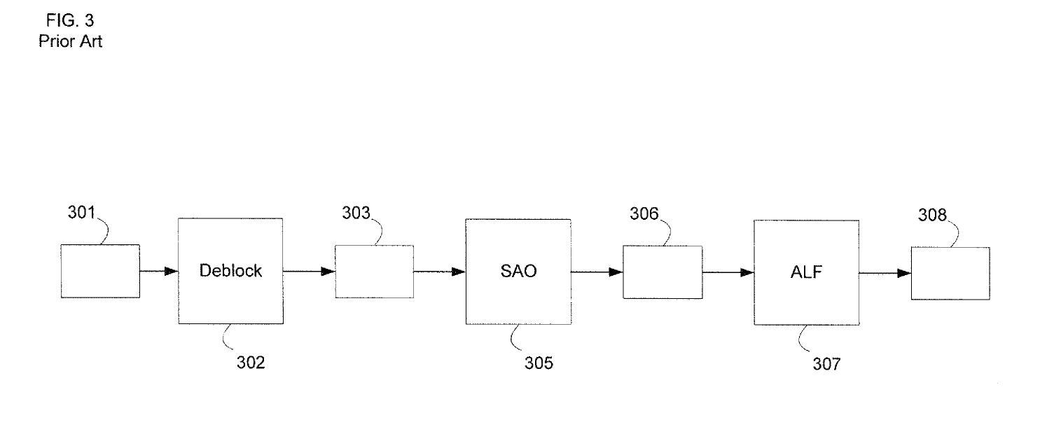

The single or multistage base layer loop filter unit (617) is described in the context of a scalable extension of HEVC, and therefore can include the same functional units of a non-scalable HEVC coder, which were already described in FIG. 3 and above. However, the disclosed subject matter is not limited to HEVC-style multistage loop filter designs, but is applicable to any loop filter design that includes at least one stage. In fact, it is also applicable to other functional units of a decoder that can be described as performing an operation between two reference pictures (that can be interim reference pictures) or parts thereof. For example, if the SAO subfilter (305) were not performing a Sample-Adaptive Offset filtering operation, but a change of the bit depth of the reference pictures, or a change in the color model, or any other non-filtering operation but is still performed in the loop, takes data from one interim reference picture, and produces another interim reference picture, the disclosed subject matter does apply. When referring above to a reference picture or interim reference picture, it is understood that, depending on the implementation, not the whole picture needs to be physically stored or be present. For example, in pipelined environments, it can be advantageous to exposed individual slices, CUs, or samples, to the multiple pipeline stages that can form a multistage loop filter. Further, sub-filters (or functional entities that cannot be described as filters but create data from one reference picture and generate a second one as descried above) can operate on parts of reference pictures potentially as small as a single sample. As such, when henceforth mentioned are (interim) reference pictures, parts of (interim) reference pictures are also meant to be included.

The input samples (301) (which can be viewed as an interim picture created by the decoder before processing by any loop filter entities) are filtered by a deblocking filter (302) configured to reduce or eliminate blocking artifacts. The resulting interim picture (303) is exposed to a sample adaptive offset (SAO) mechanism (305), and its output picture (306) is subjected to an Adaptive Loop Filter (ALF) (307). The output of the ALF can form yet another interim picture (308).

The four interim pictures (301) (303) (306) (308) are the results of various stages of the loop filter process.

The purpose of the signal (616) that can be generated by the RLSSP unit (615) can be to select one of the four interim reference pictures (301) (303) (306) (308) for use by the enhancement layer coding loop (611). It should be understood that the choice between four interim reference pictures, while appropriate for HEVC, may be inappropriate for other video coding standards. For example, if the video coding standard includes only a single stage loop filter, then there would be only two (interim) reference pictures—the pre loop-filtered reference picture and the post loop-filtered reference picture. In such a case, the RLSSP unit can select between these two pictures.

In the example shown, the RLSSP module (615) has selected the interim picture (303) created by the deblocking subfilter (302). The remaining stages of the loop filter (617) may still be executed to generate a reference picture for the base layer, as already described.

In the same or another embodiment, the aforementioned selection can involve rate distortion optimization. Rate control optimization can refer to techniques that improve the relationship between coding rate and reconstructed picture distortion, and is well known to a person skilled in the art. As an example for an applicable rate-distortion improvement technique, a scalable encoder can speculatively encode a given CU using each of the four interim pictures as input for the enhancement layer coding loop. The selection requiring the lowest number of bits for the encoding is selected. This can work because the coding overhead of the possible choices, when coded in binary format, can be identical—two bits required to indicate four possible choices.

The RLSSP unit can further place information indicative of the selection into the enhancement layer bitstream, the base layer bitstream, or elsewhere in the scalable bitstream. The information can be in the form of a two bit binary integer, where each of the four permutations of the two bits refers to one interim picture being used for the enhancement layer coding loop.

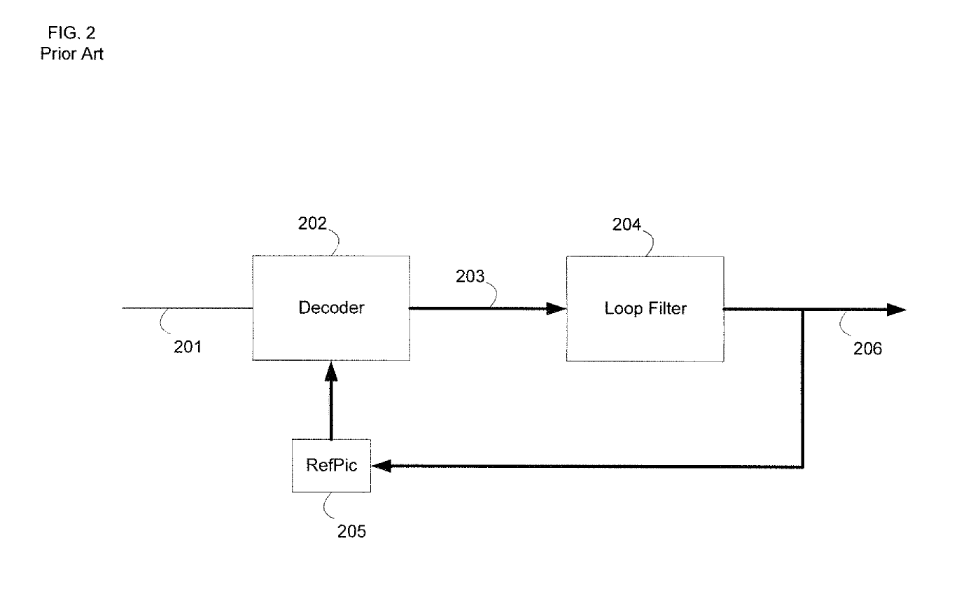

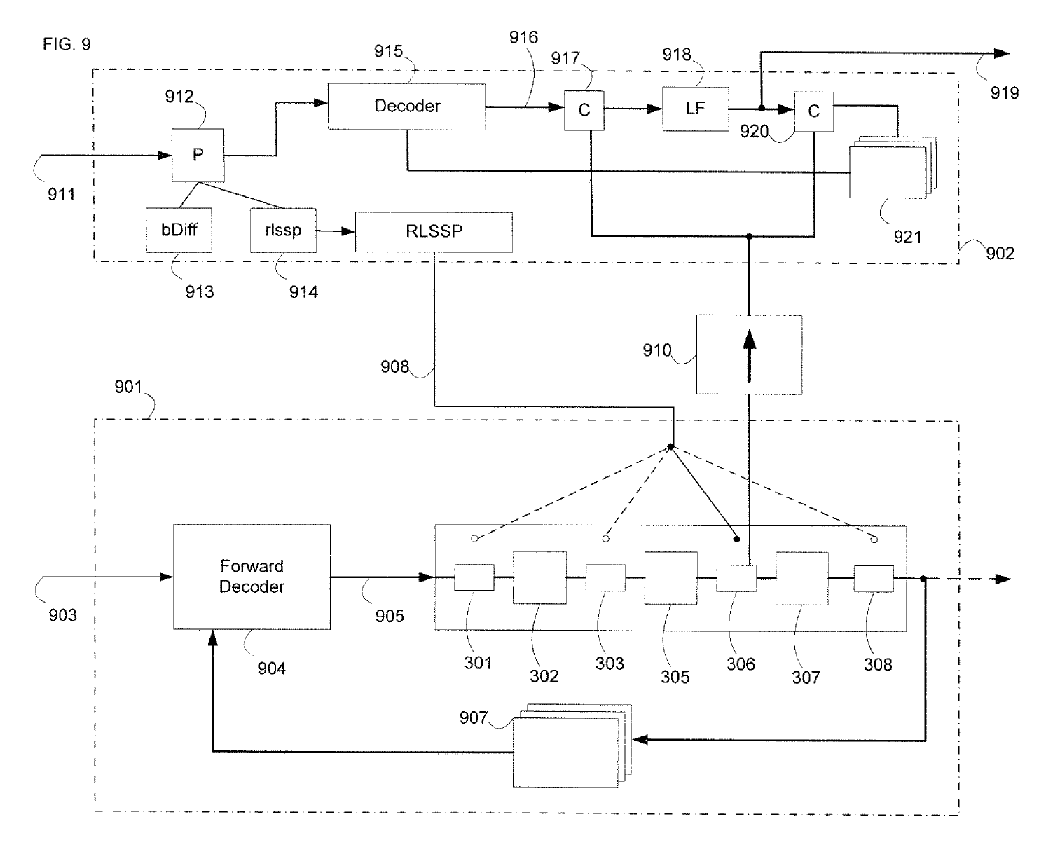

Referring to FIG. 9, shown is a scalable decoder in accordance with the disclosed subject matter. The scalable decoder can include a base layer decoder (901) and an enhancement layer decoder (902). Both base layer and enhancement layer decoder can include decoders as described in FIG. 2, with modifications as described next.

The base layer decoder (901) can receive an input base layer bitstream (903) that can be processed by a forward decoder (904). The forward decoder can create an interim picture (905). The interim picture can, for example, be exposed to a loop filter (906) that in one embodiment, can be an HEVC loop filter, and therefore include, for example all components mentioned in FIG. 3 above. In particular, the loop filter can include interim pictures (301) (303) (306) (308), as well as sub-filters deblocking filter (302), SAO (305), and Adaptive Loop Filter (307). The output of the loop filter can be stored in a reference picture buffer (907), which can be used for decoding of later coded pictures, and optionally also output to an application.

In the same or another embodiment, the loop filter can further be responsive to a signal (908), created, for example, by a decoder RLSSP module (909) that can be, for example located in the enhancement layer decoder (902). A purpose of the decoder RBSSP module can be to recreate, from the bitstream, the signal (908). The information indicative of the signal can be stored in the enhancement layer bitstream (911) as it can be possible to have more than one enhancement layer referencing the same base layer, and those more than one enhancement layers can signal different interim pictures for use up the upsampling unit (910). This can outweigh the architectural constraints that the interim pictures are located in the base layer decoder (901), which would appear to make it logical to store relevant information about the selection of such pictures in the base layer bitstream (903).

In the same or another embodiment, the signal (908) can be indicative of one of the, for example, four interim pictures (301) (303) (306) (308) that can be created by the of loop filter (906), as described above in the context of FIG. 3 and FIG. 8. The creation of the interim pictures can, and in most standardized cases must, be identical between encoder and decoder. If the creation is not identical between encoder and decoder, there can be drift.

In the same or another embodiment, depending on signal (908), when the enhancement layer coding decoder (902) requires upscaled base layer data, the signaled interim picture in the base layer loop filter (906) can be addressed. In the same or another embodiment, samples from the addressed interim picture can be upsampled by an upsample unit (910) for the use of the enhancement layer decoder (902). There can also be side information associated with the addressed loop filter interim picture, which can be upscaled in an upscale unit for use by the enhancement layer decoder (not shown).

It should be noted that the aforementioned mechanisms can operate with the enhancement layer decoder (902) operating in pixel mode or in difference mode, as described in Ser. No. 13/529,159.

The enhancement layer decoder (902) can receive an enhancement layer bitstream (911), that can, for example include a flag bDiff and/or information indicative of a signal ref layer_sample_scaling_point (rlssp signal henceforth). A parser (912) can parse bDiff (913) and/or rlssp (914) from the, for example, enhancement layer bitstream (911).

The rlssp signal can be used by the RLSSP unit (908) to control the selection of the interim loop filter pictures in the base layer, as already described.

When the flag bDiff is 1, it can be indicated that the enhancement layer decoder is working in the difference mode. Ser. No. 13/529,159 describes difference domain and pixel domain in more detail.

The generation of upscaled sample information in the base layer decoder has been described above. In the same or another embodiment, a decoder (915), that can operate on the output of the parser (912), can reconstruct difference samples from the enhancement layer bitstream (911) (directly, or using already parsed and potentially entropy decoded symbols provided by parser (912)). The reconstructed difference samples (916) can be converted into the pixel domain by converter (917), for example by subtracting the spatially corresponding upscaled sample information from the base layer so to form sample information in the pixel domain.

The pixel domain samples from converter (917) can be loop-filtered, for example according to HEVC as described in FIG. 3 in loop filter (918). The results are reconstructed samples in the pixel domain (919). These samples can be output to the enhancement layer decoder output.

When the enhancement layer decoder (902) operates in difference mode, in the same or another embodiment, the reference picture buffer (921) can also be in difference mode. Accordingly in the same or another embodiment, the pixel domain samples (919) may need to be converted into the difference domain, for example by converter (920). The output of converter (920) can be samples in the difference domain, which can be stored in reference picture buffer (921) for further processing.

Remarks made in the encoder context regarding the various conversion procedures apply as well.

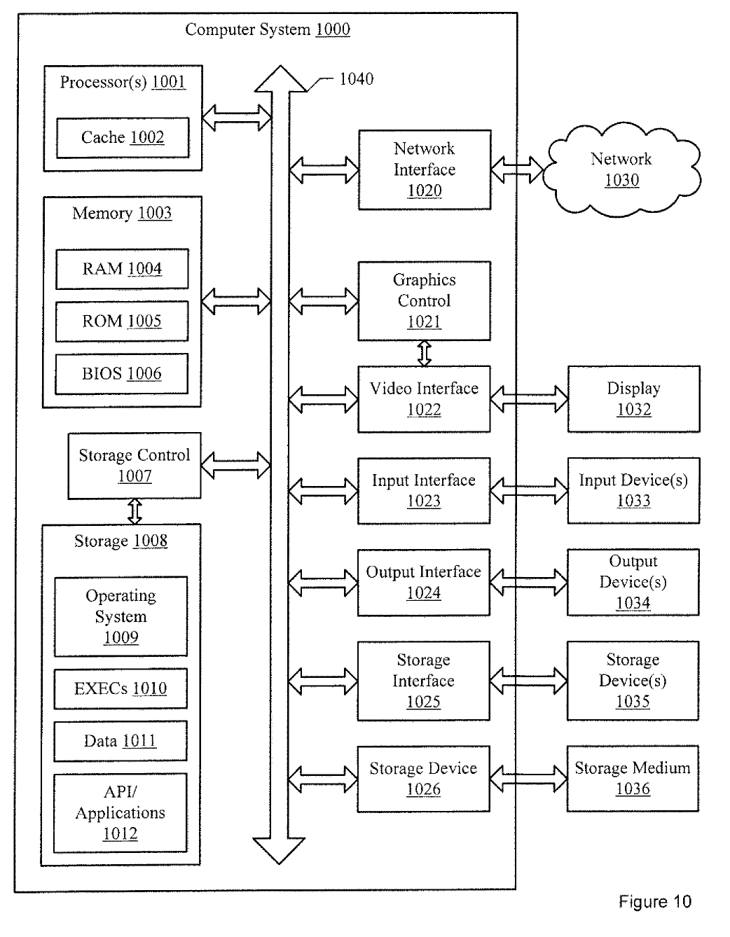

The methods for scalable coding/decoding using difference and pixel mode, described above, can be implemented as computer software using computer-readable instructions and physically stored in computer-readable medium. The computer software can be encoded using any suitable computer languages. The software instructions can be executed on various types of computers. For example, FIG. 10 illustrates a computer system 1000 suitable for implementing embodiments of the present disclosure.

The components shown in FIG. 10 for computer system 1000 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 1000 can have many physical forms including an integrated circuit, a printed circuit board, a small handheld device (such as a mobile telephone or PDA), a personal computer or a super computer.

Computer system 1000 includes a display 1032, one or more input devices 1033 (e.g., keypad, keyboard, mouse, stylus, etc.), one or more output devices 1034 (e.g., speaker), one or more storage devices 1035, various types of storage medium 1036.

The system bus 1040 link a wide variety of subsystems. As understood by those skilled in the art, a “bus” refers to a plurality of digital signal lines serving a common function. The system bus 1040 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 1001 (also referred to as central processing units, or CPUs) optionally contain a cache memory unit 1002 for temporary local storage of instructions, data, or computer addresses. Processor(s) 1001 are coupled to storage devices including memory 1003. Memory 1003 includes random access memory (RAM) 1004 and read-only memory (ROM) 1005. As is well known in the art, ROM 1005 acts to transfer data and instructions uni-directionally to the processor(s) 1001, and RAM 1004 is used typically to transfer data and instructions in a bi-directional manner. Both of these types of memories can include any suitable of the computer-readable media described below.

A fixed storage 1008 is also coupled bi-directionally to the processor(s) 1001, optionally via a storage control unit 1007. It provides additional data storage capacity and can also include any of the computer-readable media described below. Storage 808 can be used to store operating system 1009, EXECs 1010, application programs 1012, data 1011 and the like and is typically a secondary storage medium (such as a hard disk) that is slower than primary storage. It should be appreciated that the information retained within storage 1008, can, in appropriate cases, be incorporated in standard fashion as virtual memory in memory 1003.

Processor(s) 1001 is also coupled to a variety of interfaces such as graphics control 1021, video interface 1022, input interface 1023, output interface 1024, storage interface 1025, and these interfaces in turn are coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 1001 can be coupled to another computer or telecommunications network 1030 using network interface 1020. With such a network interface 1020, it is contemplated that the CPU 1001 might receive information from the network 1030, or might output information to the network in the course of performing the above-described method. Furthermore, method embodiments of the present disclosure can execute solely upon CPU 1001 or can execute over a network 1030 such as the Internet in conjunction with a remote CPU 1001 that shares a portion of the processing.

According to various embodiments, when in a network environment, i.e., when computer system 1000 is connected to network 1030, computer system 1000 can communicate with other devices that are also connected to network 1030. Communications can be sent to and from computer system 1000 via network interface 1020. For example, incoming communications, such as a request or a response from another device, in the form of one or more packets, can be received from network 1030 at network interface 1020 and stored in selected sections in memory 1003 for processing. Outgoing communications, such as a request or a response to another device, again in the form of one or more packets, can also be stored in selected sections in memory 1003 and sent out to network 1030 at network interface 1020. Processor(s) 1001 can access these communication packets stored in memory 1003 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture 1000 can provide functionality as a result of processor(s) 1001 executing software embodied in one or more tangible, computer-readable media, such as memory 1003. The software implementing various embodiments of the present disclosure can be stored in memory 1003 and executed by processor(s) 1001. A computer-readable medium can include one or more memory devices, according to particular needs. Memory 1003 can read the software from one or more other computer-readable media, such as mass storage device(s) 1035 or from one or more other sources via communication interface. The software can cause processor(s) 1001 to execute particular processes or particular parts of particular processes described herein, including defining data structures stored in memory 1003 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

We claim:

1. A method for decoding video having two or more pictures, each encoded in a base layer and one or more enhancement layers, the method comprising:
decoding, from at least one of the one or more enhancement layers of a first picture, at least one information rlssp indicative of a stage in a multistage loop filter,
reconstructing at least one sample of the at least one enhancement layer of the first picture, and
using at least one upsampled sample of a base layer of a second picture associated with an output of the stage in the base layer loop filter indicated by the information rlssp in the enhancement layer loop filter.

2. The method of claim 1, wherein:
rlssp has two possible values, and
the stage in the base layer loop filter indicated by rlssp is one of:
a non loop-filtered base layer reference picture; or
a loop-filtered base layer reference picture.

3. The method of claim 1, wherein:
rlssp has four possible values, and
the stage in the base layer loop filter indicated by rlssp is one of:
a non loop-filtered base layer reference picture;
an interim reference picture created by an output of a deblocking stage;
an interim reference picture created by an output of a Sample Adaptive Offset stage; or
a reference picture created by an output of an Adaptive Loop Filter stage.

4. The method of claim 1, wherein the using at least one upsampled sample of the interim base layer reference picture comprises adding or subtracting the upsampled sample of the interim base layer reference picture to a reconstructed enhancement layer sample.

5. A method for encoding video in a base layer and at least one enhancement layer wherein at least one sample of the enhancement layer is inter-layer predicted from at least one sample of a base layer, the method comprising:
encoding the least one sample of a base layer;
encoding the least one sample of an enhancement layer in a forward encoder;
selecting one of a plurality of loop-filter stages of the base layer;
loop-filtering the at least one sample of the base layer up to the selected stage of the loop filter of the base layer;
up-sampling the at least one loop-filtered sample of the base layer; and
using the up-sampled at least one loop-filtered sample of the base layer for inter-layer prediction of the sample of the enhancement layer.

6. The method of claim 5, further comprising
encoding the selected one of a plurality of loop-filter stages of the base layer in an indication rlssp in an enhancement layer bitstream.

7. The method of claim 5, wherein:
rlssp has two possible values, and the stage in the base layer loop filter indicated by rlssp is one of:
an un loop-filtered base layer reference picture; or
a loop-filtered base layer reference picture.

8. The method of claim 5, wherein:
rlssp has four possible values, and
the stage in the base layer loop filter indicated by rlssp is one of:
an un loop-filtered base layer reference picture;
an interim reference picture created by an output of a deblocking stage;
an interim reference picture created by an output of a Sample Adaptive Offset stage; or
a reference picture created by an output of an Adaptive Loop Filter stage.

9. The method of claim 5, wherein the using at least one upsampled sample of the interim base layer reference picture comprises adding or subtracting the upsampled sample of the interim base layer reference picture to an reconstructed enhancement layer sample.

10. The method of claim 5, wherein the selection involves a rate-distortion optimization.

11. A non-transitory computer-readable medium comprising a set of instructions to direct a processor to perform the methods of one of claims 1 to 10.

12. A system for decoding video having two or more pictures, each encoded in a base layer and one or more enhancement layers, the system comprising:
a decoder configured to:
decode, from at least one of the one or more enhancement layers of a first picture, at least one information rlssp indicative of a stage in a multistage loop filter,
reconstruct at least one sample of the at least one enhancement layer of the first picture, and
use at least one upsampled sample of a base layer of a second picture associated with an output of the stage in the base layer loop filter indicated by the information rlssp in the enhancement layer loop filter.

13. The system of claim 12, wherein:
rlssp has two possible values, and
the stage in the base layer loop filter indicated by rlssp is one of:
a non loop-filtered base layer reference picture; or
a loop-filtered base layer reference picture.

14. The system of claim 12, wherein:
rlssp has four possible values, and
the stage in the base layer loop filter indicated by rlssp is one of:
a non loop-filtered base layer reference picture;
an interim reference picture created by an output of a deblocking stage;
an interim reference picture created by an output of a Sample Adaptive Offset stage; or
a reference picture created by an output of an Adapative Loop Filter stage.

15. The system of claim 12, wherein the decoder is further configured to add or subtract the upsampled sample of the interim base layer reference picture to a reconstructed enhancement layer sample.

16. A system for encoding video in a base layer and at least one enhancement layer wherein at least one sample of the enhancement layer is inter-layer predicted from at least one sample of a base layer, the system comprising:
an encoder configured to:
encode the least one sample of a base layer;
encode the least one sample of an enhancement layer in a forward encoder;
select one of a plurality of loop-filter stages of the base layer;
loop-filter the at least one sample of the base layer up to the selected stage of the loop filter of the base layer;
up-sample the at least one loop-filtered sample of the base layer; and
use the up-sampled at least one loop-filtered sample of the base layer for inter-layer prediction of the sample of the enhancement layer.

17. The system of claim 16, wherein the encoder is further configured to:
encode the selected one of a plurality of loop-filter stages of the base layer in an indication rlssp in an enhancement layer bitstream.

18. The system of claim 16, wherein:
rlssp has two possible values, and
the stage in the base layer loop filter indicated by rlssp is one of:
an un loop-filtered base layer reference picture; or
a loop-filtered base layer reference picture.

19. The system of claim 16, wherein:
rlssp has four possible values, and
the stage in the base layer loop filter indicated by rlssp is one of:
an un loop-filtered base layer reference picture;
an interim reference picture created by an output of a deblocking stage;
an interim reference picture created by an output of a Sample Adaptive Offset stage; or
a reference picture created by an output of an Adaptive Loop Filter stage.

20. The system of claim 16, wherein the encoder is further configured to add or subtract the upsampled sample of the interim base layer reference picture to an reconstructed enhancement layer sample.

21. The system of claim 16, wherein the encoder is further configured to perform a rate-distortion optimization.
